(19) United States
(12) Patent Application Publication
(10) Pub. No.: US 2022/0325467 A1
(43) Pub. Date: Oct. 13, 2022

(54) RE-COLORING OF COLORED THREADS

(71) Applicant: TWINE SOLUTIONS LTD., Petach Tiqva (IL)

(72) Inventors: Mirta PERLMAN, Beit Elazar (IL); Gilad GOTESMAN, Even-Yehuda (IL); Alon MOSHE, Petach Tiqva (IL)

(21) Appl. No.: 17/641,888

(22) PCT Filed: Sep. 11, 2020
(86) PCT No.: PCT/IL2020/050999

§ 371 Date: Mar. 10, 2022

Related U.S. Application Data
(60) Provisional application No. 62/898,674, filed on Sep. 11, 2019.

(51) Int. Cl. D06P 1/00; G06T 7/90

(52) U.S. Cl. CPC D06P 1/0032; G06T 7/90; G06T 2207/10024

(57) ABSTRACT

A system and methods are provided for repurposing a colored thread, including determining a base-to-target ink formula that specifies proportions of one or more inks to apply in re-coloring the colored thread from a base color to a target color.

### FIELD OF THE INVENTION

The present invention relates to the field of textile dyeing, and in particular to dyeing of threads.

### BACKGROUND

Threads are traditionally dyed by being immersed in a bath of dyes at a preset temperature and pressure for a specific period of time in order to achieve a target color. By contrast, digital thread dyeing systems dye a single thread (rather than bulks), utilizing a limited number of dyes (more commonly referred to as “inks,” when used with digital systems) combined in different proportions to create different colors, similar to the process applied by ink jet printers for printing documents and photographs.

Digital systems generally require four “base” inks: cyan, magenta, yellow, and black (CMYK). Adding more inks can enlarge the gamut of colors that can be achieved.

Threads (and yarns, etc.) are often colored for a specific job. Excess thread that remains after a job is completed typically has little value. Such thread may be dyed black if a company has a sufficient need for black thread as well as inexpensive access to a black dying system. Considerations for black dyeing may include costs of transporting thread to dyeing plants, as well as costs of storage. Additional considerations may include the thread color and quality of thread, as well as the potential shelf life. Bleaching may also be performed to create an off-white color. If the benefits are not sufficient to warrant re-dyeing, thread is usually disposed in landfills.

Ecological dyeing solutions on-site or near textile manufacturers would reduce overhead costs of re-dying. A method of re-dyeing (i.e., re-coloring) to non-black colors would increase the value of unused thread.

### SUMMARY

An aim of the present invention is to provide a system and method for re-coloring previously colored thread, making the thread available for new purposes. Embodiments of the present invention provide a system and methods for repurposing a colored thread comprising determining a base-to-target ink formula that specifies proportions of one or more inks to apply in re-coloring the colored thread from a base color to a target color.

Embodiments may further include: determining a white-to-target ink formula that specifies proportions of one or more inks required for coloring a white thread to achieve the target color; determining a white-to-base ink formula that specifies proportions of one or more inks required for coloring a white thread to achieve the base color; and responsively to determining the white-to-target and white-to-base ink formulas, determining the base-to-target ink formula, wherein the amount of each ink specified by the base-to-target ink formula is a function of a difference between the amount of the given ink in the white-to-target ink formula and the amount of the given ink in the white-to-base ink formula.

Some embodiments may further include determining, when any of the one or more ink proportions of the white-to-base ink formula are greater than in the white-to-target ink formula, that re-coloring to the target color is not possible. The amount of each ink in the base-to-target ink formula may be a function of thread parameter. Additionally or alternatively, the amount of each ink in the base-to-target ink formula may be a function of a process parameter.

Embodiments may also include measuring a color spectrum of the base color and/or of the target color with a color measuring device and responsively determining the white-to-base or white-to-target, respectively, ink formula.

Some embodiments may include measuring color values of the base color, and may be performed with an app of a mobile device or any other computing device with a camera input and responsively determining the white-to-base ink formula. Further embodiments may include storing the base-to-target ink formula in memory of a digital dyeing system, loading the one or more dyes of the base-to-target ink formula to the dyeing system, loading the colored thread to the dyeing system, and dyeing the colored thread according to the base-to-target ink formula.

In some embodiments the white-to-target formula may define a color not within a gamut of a dyeing machine used to re-color the colored thread and the white-to-base formula may include an amount of an ink not available on the dying machine, such that re-coloring the colored thread to the target thread color is achievable on the dyeing machine.

Further embodiments of the present invention provide a method for selecting a thread to re-color to a desired target color, wherein the re-coloring is performed by a dyeing system. The method may include: determining a white-to-target ink formula that specifies proportions of one or more inks required for coloring a white thread to achieve the desired target color; determining a base gamut of possible white-to-base ink formulas, wherein each white-to-base ink formula specifies proportions of one or more inks required for coloring a white thread to a color of a base thread, and wherein the base gamut includes only white-to-base ink formulas for which each ink value in the white-to-target ink formula is greater or equal to the value of the respective dye in the white-to-base ink formula; responsively determining the base gamut, selecting a base thread having a white-to-base ink formula in the base gamut; and responsively determining a base-to-target ink formula for re-coloring the selected base thread to achieve the desired target color.

Selecting the base color may include scanning multiple available threads with a color measuring device. The color measuring device may be configured to determine thread colors of each of the scanned multiple threads and to determine which of the thread colors is in the base gamut, and the base color may be selected as the color of an available thread that is in the base gamut. The target color may be outside a white-to-target color gamut of the dyeing system, and the base thread color may be outside the white-to-target color gamut and extends the base-to-target gamut of the dyeing system to include the target color.

In further embodiments, the target color is a set of multiple target colors, and wherein determining a base gamut of colors of threads that can be re-colored to achieve the target color comprises determining a base gamut of colors of threads that can be re-colored to achieve all the multiple target colors.

Further embodiments of the present invention provide a system including a processor and memory, the memory including instructions that when executed on the processor perform a method of repurposing a colored thread that includes determining a base-to-target ink formula that specifies proportions of one or more inks to apply in re-coloring the colored thread from a base color to a target color.

### BRIEF DESCRIPTION OF DRAWINGS

For a better understanding of various embodiments of the invention and to show how the same may be carried into effect, reference will now be made, by way of example, to the accompanying drawings, in which:

FIG. 1 is a flow diagram, depicting a process of re-coloring thread, according to some embodiments of the present invention;

FIG. 2 is a depiction of a process of alternate ink formula generation, according to some embodiments of the present invention;

FIGS. 3 and 4 are graphs of color gamuts achievable by a dyeing system and of colors achievable by re-coloring processes, according to some embodiments of the present invention; and

FIG. 5 is a graph of a portion of a gamut, exemplifying the color extrapolation process, according to some embodiments of the present invention.

Structural details of the invention are shown to provide a fundamental understanding of the invention, the description, taken with the drawings, making apparent to those skilled in the art how the several forms of the invention may be embodied in practice.

### DETAILED DESCRIPTION

In certain conditions it is required to re-color a thread that was previously dyed at a certain color. In such a situation, it is not possible to reach the desired color by dyeing the thread with standard colors as done when dyeing a white thread, since the previous dye(s) affect the final outcome. Accordingly, calculations are required to determine which color or colors should be used to re-color a pre-dyed thread to a desired color.

Accordingly, the present invention provides a method for repurposing a colored thread, the method comprising determining a base-to-target ink formula that specifies one or more ink proportions of one or more inks to apply in re-coloring the colored thread from a base color (i.e. the color of the dyed thread) to a target color (i.e. the desired final color), wherein determining said base-to-target ink formula comprises the steps of: (a) determining a white-to-target ink formula that specifies proportions of one or more inks required for coloring a white thread to achieve the target color; (b) determining a white-to-base ink formula that specifies proportions of one or more inks required for coloring a white thread to achieve the base color; and (c) subsequently determining the base-to-target ink formula by determining the difference between the amount of the given ink in the white-to-target ink formula and the amount of the given ink in the white-to-base ink formula, thereby determining the amount of each given ink specified by the base-to-target ink formula.

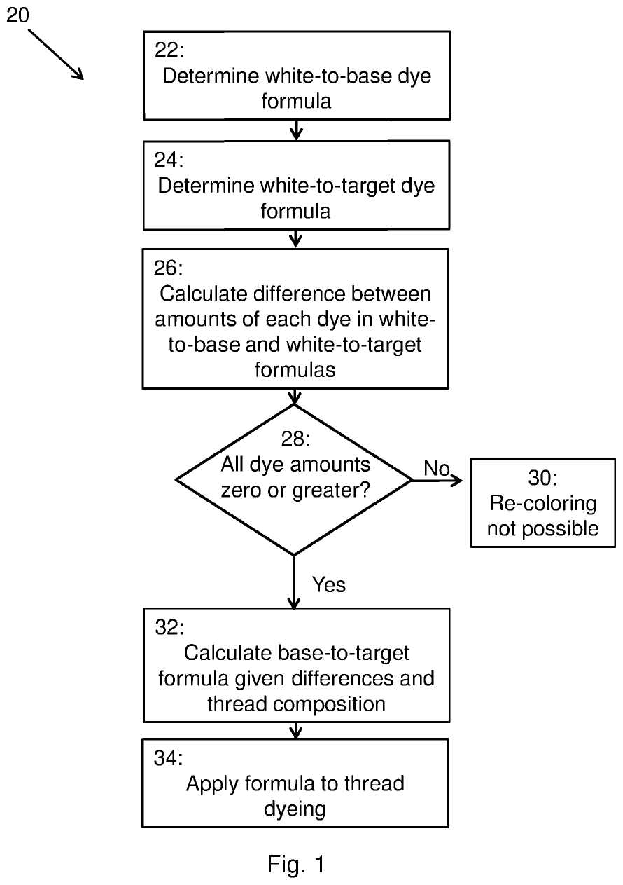

A workflow of the methodology applied here is presented in FIG. 1, which shows a process 20 for determining and applying an ink formula for re-coloring a colored thread. Hereinbelow, the term “re-coloring” (also referred to as “repurposing”) means applying one or more inks to a previously dyed thread (also referred to hereinbelow as a colored thread or “base” thread) in order to achieve a new color. An ink formula specifies the proportions of inks (or dyes) to apply to a base thread to obtain a desired color. The gamut of new colors that can be achieved when re-coloring may extend beyond the gamut of a given dyeing system, meaning that use of a colored base thread extends the effective color gamut of the dyeing system.

As shown in FIG. 1, sometimes it is not possible to recolor a thread since there is not enough ink of a certain color in the dyeing machine, or since the base color is too strong/dark making it impossible to reach the target color. The method of the invention can determine/identify such cases and notify the user. As such, the method of the invention may further comprise determining, when any one of the one or more ink proportions of the white-to-base ink formula are greater than in the white-to-target ink formula, that re-coloring to the target color is not possible.

Dyeing a thread, whether by a traditional process or by a digital process, involves impregnating ink into core fibers of a thread rather than coating the thread; consequently, additional ink added to a previously dyed thread modifies the initial color, rather than replacing the original color with the new ink's color. For example, to reach a reddish hue when starting with a yellow thread, one would apply a magenta ink to the thread, thereby changing the color of the thread to reach the desired outcome.

The final color of a thread after re-coloring is a function of the original ink proportions (or “dyes”) and the re-coloring ink proportions. The final color is also a function of thread characteristics, and mechanical process parameters. Thread characteristics may include type of material (thread composition), number of fibers, shape, twist, texturization, strength, weight and diameter. Process parameters may include process temperature, dye uptake, thread tension and velocity applied during the dyeing process. A digital dyeing system for applying an ink formula to a thread may be a digital dyeing system as described in WO 2017/203524. The system may include ink cartridges and may be adapted to control the timing of applying ink from each cartridge to a thread according to at least one of: the desired target color; the thread characteristics; process parameters and the moving pace of the thread portion at the treatment head. Accordingly, in certain embodiments, the amount of each ink in the base-to-target ink formula is further affected by one or more thread parameters or by one or more process parameters, or any combination thereof.

The present invention further provides a system utilizing the method of the invention, the system comprises a processor and memory including instructions that when executed on the processor perform a method of repurposing a colored thread, the method comprising determining a base-to-target ink formula that specifies one or more ink proportions of one or more inks to apply in re-coloring the colored thread from a base color to a target color, wherein determining said base-to-target ink formula comprises: (i) receiving a white-to-target ink formula that specifies proportions of one or more inks required for coloring a white thread to the target color; (ii) receiving a white-to-base ink formula that specifies proportions of one or more dyes required for coloring a white thread to the base color; and (iii) responsively to determining the white-to-target and white-to-base ink formulas, determining the base-to-target formula, wherein the amount of each ink specified by the base-to-target formula is a function of a difference between the amount of the given dye in the white-to-target ink formula and the amount of the given ink in the white-to-base ink formula.

In certain embodiments, the method of the invention further comprises a step of measuring a color spectrum of the base color and/or the target color, e.g. with a color measuring device, and responsively determining the white-to-base ink formula or the white-to-target ink formula, respectively. Alternatively, or additionally, the method may include a step of measuring color values of the base color using a dedicated application (“app”) of a mobile device or other computing device equipped with a camera input for determining the white-to-base ink formula and/or the white-to-target ink formula. Alternatively, a camera can be used to capture an image of the color and transmit same to a computing device with such an app.

The gamut space of colors achievable by re-coloring a colored thread typically does not include all colors that are in the gamut of colors achievable when dyeing a white thread (i.e., a thread that has not been colored). For example, a yellow thread cannot be dyed to pure cyan or magenta, colors that do not include any yellow hue. At the same time, the gamut based on a colored thread extends, in some areas, beyond the gamut that can be achieved with a white base thread. That is, the color gamut of a dyeing machine may be extended by use of a colored base thread, depending on the initial color of the base thread. As an example, if a base thread is a shade of blue that is outside of the gamut space of the dyeing system, the gamut of colors that may be achieved by re-coloring the thread also extends beyond the original gamut space of the dyeing system (the “original gamut space” being the range of colors achievable with a white base thread). In addition, a colored base thread that is in the original gamut of a dyeing system may also extend the system's gamut. For example, a base thread that was dyed on the system with 20% yellow ink can subsequently be re-dyed with 100% yellow, generating a 120% yellow ink, that is also beyond the original gamut.

Consequently, if a target color is beyond the gamut of a dyeing system, the target color may be achieved by using a colored base thread. The proper selection of a colored base thread to reach the desired target can therefore extend the gamut of a dyeing system that has a limited set of inks. A set of multiple colored base threads can significantly extend the gamut of such a dyeing system.

In some embodiments of the present invention, colored threads are dyed by determining proportions or amounts of inks to use for a re-coloring, on a dyeing system with a limited number of available “base” inks, such as cyan, magenta, yellow and black (CMYK). Color coordinates of a “target” color, may be given in device dependent coordinates, such as RGB, or in device independent coordinates, such as CIEXYZ or CIELab industry standards, or as spectral values, which are converted to ink values.

Proportions of colors specified by ink formulas, together with process parameters, and, optionally, ink parameters and thread characteristics, which may be defined as “Software Thread Related Input Parameters” (STRIP™), facilitate digital dyeing to the desired target color.

A digital dyeing process, implemented by a dyeing system, may specify a mathematical dyeing function that defines a color model, which is a transform from an “ink space” to a “color space”, based on spectral color values or device independent color values, such as the industry standard L*a*b* color space, (L* being the lightness from black to white, a* being a green to red scale, and b* being a blue to yellow scale), or alternative spaces, such as the XYZ space. The range of colors that can be achieved by the set of inks constitutes the gamut of the device. An inverse color model, defines the opposite transform, from spectral or device independent color spaces to the ink space. The model defines thread response to inks and is typically accompanied by a set of process parameters and STRIP parameters, which together define or calculate an expected result of dyeing. These models may also be represented as color tables that are a discretization of the color dyeing function. Tables may be used for convenience in a color management module of the dyeing system.

Mathematically, a color model \vec{ƒ}( ) is a vector function of parameters that include: ink quantities or proportions Ink₁, . . . , Inkₖ, process parameters Pr₁, . . . , Pr_{N}, and thread parameters Th₁, . . . , Thₘ. Process parameters, as described above, include parameters such as temperatures and flow times; thread parameters, as described above, include parameters such as thread composition, weight, and thickness. The color model characterizes the gamut of a dyeing system, by defining the relationships between ink proportions in an ink space and the corresponding color values of those ink proportions in a device independent color space, such as the industry standard L*, a*, b* space. A color value is indicated in the following equation as (Lab):

\vec{ƒ}(Ink₁, . . . ,Inkₖ,Pr₁, . . . ,Pr_{N},Th₁, . . . ,Th_{M})=(Lab)

The vector function \vec{ƒ} can be a polynomial equation that determines the corresponding transform used to convert a given input color to a corresponding output color, accounting not only for the dyes (i.e., inks) used but for additional process and thread parameters.

As an example, the vector function for four inks—cyan, magenta, yellow and black—inherently indicates process and thread parameters embedded in the relationship between ink and color, via a sampling process of several ink combinations:

\vec{ƒ}(C,M,Y,K)=Σᵢ₌₀^{N}C^{α}^{ᵢ}M^{β}^{ᵢ}Y^{γ}^{ᵢ}K^{δ}^{ᵢ}0≤αᵢ,βᵢ,γᵢ,δᵢ≤N,

where N is the polynomial degree.

The inverse model describes a mapping from a colorimetric value in a device independent color space to an ink space specifying ink proportions, that is, the inverse (ƒ⁻¹ ( )) of the color model:

(Ink₁, . . . ,Inkₖ)=\vec{ƒ⁻¹}(Lab)

Hereinbelow, the term “ink formula”, i.e., (Ink₁, . . . , Inkₖ), refers to the proportions of inks or dyes used to achieve a given thread color. Proportions may be specified as ratios or as absolute amounts.

An ink formula may be determined by a minimization process, minimizing a distance measure between colors (distance in a color space being defined, for example, by industry terms dE_{ab}, dE_{CMC}, or dE₀₀). The minimization usually includes constraints on one or more of the inks to attain a single smooth solution:

min_{(Ink}_{₁}_{, . . . ,Ink}_{_{K}}₎∥Lab−ƒ(Ink₁, . . . ,Inkₖ,Pr₁, . . . ,Prₙ,Th₁, . . . ,Thₘ)∥/constraints

where the horizontal “∥” brackets indicate the distance measure to be minimized.

At a step 22 of process 20, an existing colored thread is selected for re-coloring. A colorimetric value of the existing thread is referred to hereinbelow as a “base color,” or Lab_{B}. If the base color is known, then a corresponding “white-to-base ink formula” (Ink_{B}¹, . . . , Ink_{B}^{k}) may be calculated from the inverse model, the formula specifying the proportions or amounts of each:

(Ink_{B}¹, . . . ,Ink_{B}^{k})=\vec{ƒ⁻¹}(Lab_{B})

If Lab_{B} is not known, several alternative methods may be used to determine the white-to-base ink formula. One method is to have prior knowledge of the inks that were applied with the given device. Alternatively, the color spectrum of the thread may be measured with a color measuring device, such as a spectrophotometer, or RGB color coordinates may be measured by an “app” of a mobile computing device having a digital camera, or any other computing device with a camera input, or any other spectral measuring device. The results of these measurements may be converted to the coordinates of Lab_{B} or directly to the white-to-base ink formula (or the white-to-target ink formula) from appropriate inverse models.

At a step 24 of process 20, a “white-to-target ink formula,” (Ink_{T}¹, . . . , Ink_{T}^{k}), is determined for a desired target color of thread that is needed for a new job. If the white-to-target ink formula is not known, but a colorimetric value Lab_{T} of the target color is known, then the corresponding “white-to-target ink formula” may similarly be calculated from the inverse model:

(Ink_{B}¹, . . . ,Ink_{B}^{k})=\vec{ƒ⁻¹}(Lab_{B})

As above, if the target thread color is not in the gamut of the dyeing system, this conversion requires extrapolation of ink formulas beyond the system gamut as is explained hereinbelow.

Once the white-to-target ink formula and the white-to-base ink formula are known, a difference between the formulas may be calculated by vector subtraction of the inks of the respective formulas at a step 26 to determine if recoloring to achieve the target color is possible. If the ink differences are positive or zero, then re-coloring is determined to be possible (step 32). If all ink differences are not greater or equal to zero (decision step 28), then the base thread cannot be re-colored to achieve the target color (step 30): Recoloring to the target color is possible if the ink differences are zero or positive, otherwise the base thread cannot be recolored to the target thread. The base-to-target ink formula, (Ink_{N}^{k}, . . . , Ink_{N}^{k}), may be a function of the ink differences, as well as of the process parameters Pr₁, . . . , Pr_{N} and thread parameters Th₁, . . . , Thₘ, as described above, giving:

(Ink_{N}¹, . . . ,Ink_{N}^{k})=(Ink_{T}¹, . . . ,Ink_{T}^{k})−(Ink_{B}¹, . . . ,Ink_{B}^{k})

0≤(Ink_{N}¹, . . . ,Ink_{N}^{k})≤100

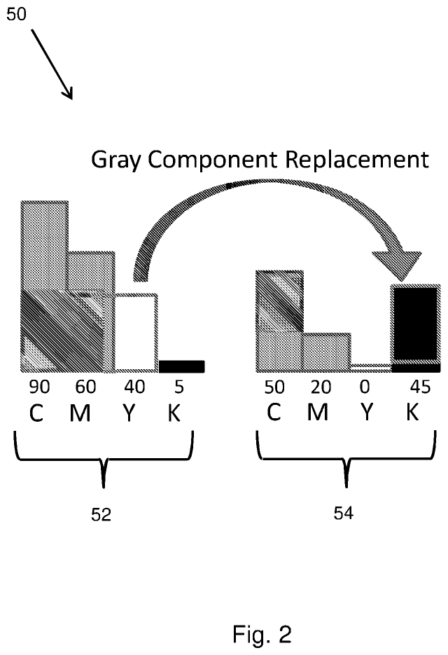

Alternatively, if not all ink differences are positive or zero, we may seek a different ink solution for either the target or the base color or both, such that the difference becomes positive and recoloring is possible. This can be done because in some cases there is more than one solution to the inversion of the model. For example, multiple solutions exist when, in the ink formula, either all cyan, magenta and yellow are positive or black is less than 100%. As indicated in FIG. 2, alternate solutions may be generated by a process 50 called “gray component removal”: Assume an initial ink formula 52 is (C,M,Y,K)=(90, 60, 40, 5). We assume that equal parts of C, M and Y form the color gray. The maximum amount of ink that can be removed from C, M and Y is therefore 40, resulting in formula 54, where (C,M,Y,K)=(50, 20, 0, 45). An alternative solution would be to move 5% of the black ink to C,M,Y, where (C,M,Y,K)=(95, 65, 45,0).

Alternatively, if the base and target colors are not in the gamut of the dyeing system, the base-to-target ink formula can nevertheless be determined by extrapolating the inverse model ƒ⁻¹(Lab) to obtain (Ink_{B}^{1E}, . . . , Ink_{B}^{kE}), where the index E means extrapolation. Assume Lab_{T} is given by one of the methods stated above, in the same way, we can extrapolate to obtain (Ink_{T}^{1E}, . . . , Ink_{T}^{kE}). Given these 2 n-tuples, we can now calculate the amount of ink to be used in dyeing the base thread:

(Ink_{N}^{1E}, . . . ,Ink_{N}^{kE})=(Ink_{T}^{1E}, . . . ,Ink_{T}^{kE})−(Ink_{B}^{1E}, . . . ,Ink_{B}^{kE})

0≤(Ink_{N}^{1E}, . . . ,Ink_{N}^{kE})≤100

If a base thread is selected for re-coloring, the gamut of possible target colors achievable by re-coloring is the set of colors for which each ink value in the white-to-target ink formula is greater or equal to the value in the white-to-base ink formula of the selected base thread:

Target Gamut={(Ink_{T}¹, . . . ,Ink_{T}^{k})|(Ink_{T}¹, . . . ,Ink_{T}^{k})≥(Ink_{B}¹, . . . ,Ink_{B}^{k})}

The above definitions hold for any number of inks-k.

Conversely, a desired target thread color may first be chosen, as needed for a given project, and a base thread may then be chosen from among multiple available base threads, for example by scanning the colors of the multiple available threads stored in a database. The base thread to be used for the project may be selected based on its being in the gamut of possible colors (i.e., base colors) that a given dyeing system can re-color to achieve the desired target thread. Additionally, multiple target colors may be required for a given project, and, given multiple available base threads, a selection of one or more of the multiple base threads may be made based on determining which of the available threads can be re-colored to achieve the target colors. For example, a project may require 8 target colors, and it may be determined that a set of just two base threads can be re-colored, with different formulas, to achieve all 8 target colors, thereby reusing thread and saving set-up time.

The gamut of possible base thread colors is a set of all colors for which each ink value (i.e., the amount or proportion of ink to be used) in the white-to-target ink formula of the desired target is greater or equal to the value in the white-to-base ink formula of the base thread:

$$Base Gamut = \{ \begin{matrix}( {Ink}_{B}^{1} , … , {Ink}_{B}^{k} ) \vert ( {Ink}_{T}^{1} , … , {Ink}_{T}^{k} ) \geq ( {Ink}_{B}^{1} , … , {Ink}_{B}^{k} ) , \\ 0 \leq {Ink}_{B}^{1} \leq 100 , k = 1 , … , k\end{matrix} \}$$

As mentioned above, the definition holds for any number of inks, k. In a further embodiment, multiple target colors may be specified, and the base gamut is determined as the gamut for which the white-to-base ink formula is less than or equal to the white-to-target ink formula of all the multiple target colors. A “best” base thread may be selected, for example, as one that can achieve the most target colors for a given project. Alternatively or additionally, constraints can be set to allow an algorithm to choose a base thread from among several alternatives. For example, selection may be made according to the base colored thread that requires the least amount of additional inks (thereby promoting reduced ink usage). Selection may alternatively or additionally be made according to a constraint, such as selecting a base colored thread that allows the target color to be obtained with the application of no more than two inks.

A mobile computing device, or any other computing device with a camera input, may be configured to capture thread colors of available threads and to apply the process described herein to select one thread that would be appropriate for re-coloring to a desired target color using the given dyeing system.

Once a base-to-target ink formula is determined, and in accordance with the method of the invention, it may be stored in memory of a digital dyeing system, such as that described above. The dyeing system may be loaded with the one or more dyes/inks of the base-to-target ink formula, together with the base thread, which is then dyed according to the base-to-target ink formula (step 34).

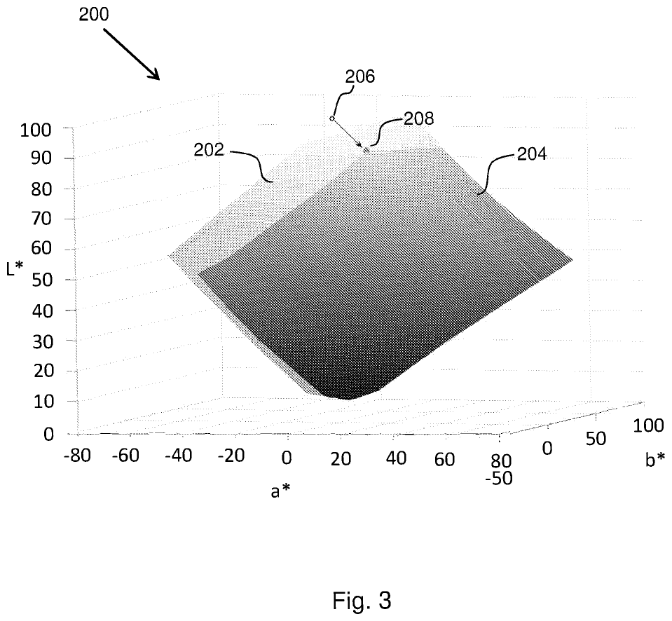

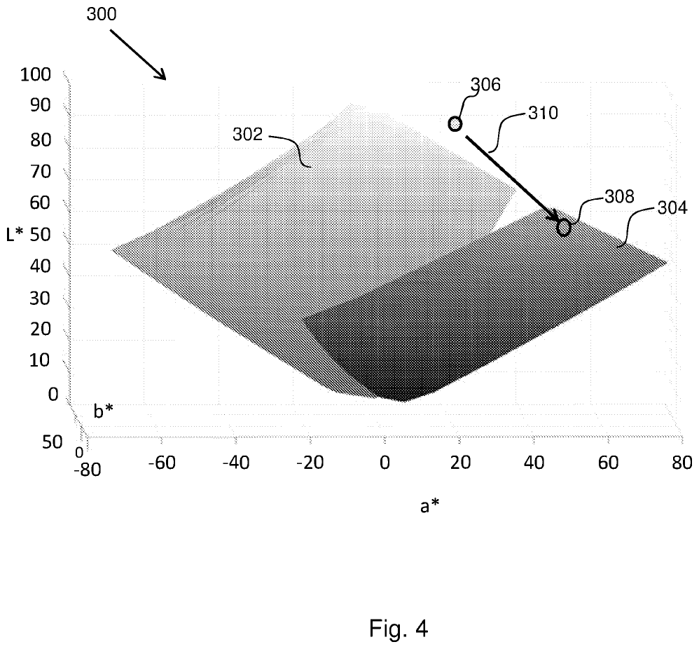

FIGS. 3 and 4 are graphs of color gamuts achievable by a dyeing system and of thread colors achievable by re-coloring processes, according to some embodiments of the present invention. FIG. 3 shows a graph of a colorimetric space 200, indicated as an industry standard color space (Such as L*a*b*). Shown is a dyeing system gamut 202 of colors achievable by a given dyeing system, and a re-coloring gamut 204 achievable when the system is used to re-color a thread having a color indicated as base color 206. A base-to-target ink formula may be applied to color the thread to the target color 208.

FIG. 4 shows a graph of a colorimetric space 300, also indicated as an industry standard L*a*b* color space. Shown is a dyeing system gamut 302 of colors achievable by a given dyeing system. If a base color of a colored thread, such as a base color 306, includes a colorant or hue not available to the given dyeing system, then the base color 306 is not in the dyeing system gamut 302. Consequently, the re-coloring gamut 304 achievable when the system is used to re-color the base thread is also not a subset of the dyeing system gamut 302, but extends beyond that gamut. Consequently, a target color 308, outside the original dyeing system gamut 302, can be achieved, by dying the colored thread according to a base-to-colored formula 310.

Accordingly, in certain embodiments of the method of the invention, the white-to-target formula defines a color not within a gamut of a dyeing machine used to re-color the colored thread and wherein the white-to-base formula includes an amount of an ink not available on the dying machine, such that re-coloring the colored thread to the target thread color is achievable on the dyeing machine.

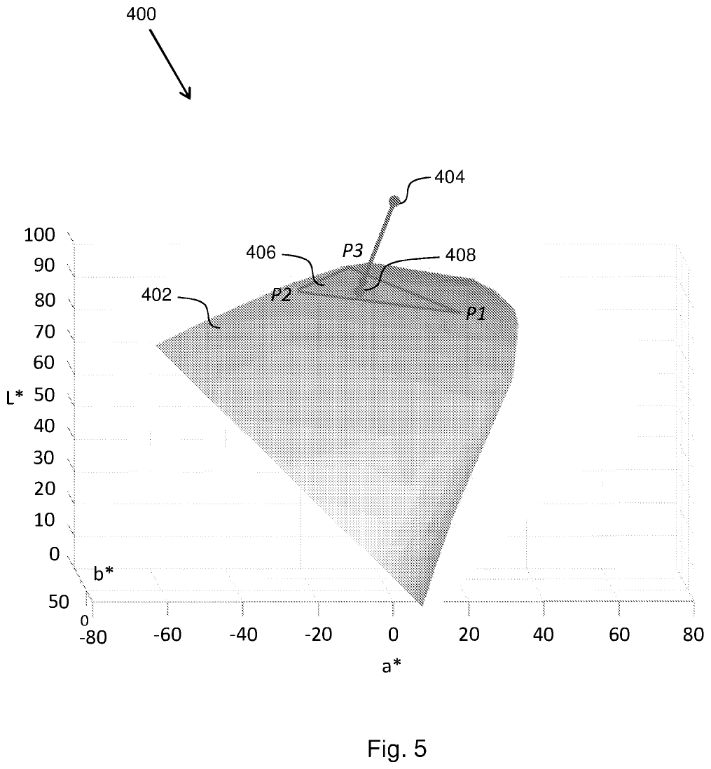

FIG. 5 shows a graph of a colorimetric space 400, also indicated as an industry standard L*a*b* color space. Shown is a portion of the dyeing system gamut 402 of colors achievable by a given dyeing system and an out of gamut color 404. The out of gamut color 404 can be the base and/or target color of the thread. The ink composition of an out-of-gamut color 404 can be determined by extrapolation of inks used to achieve gamut 402 as follows: A “Gamut Boundary Descriptor” is a collection of vertices in Lab (or LCH) space connected to form non-overlapping triangles that together describe the gamut surface. Let a “surface” of the 3-D gamut, portrayed in the space 400, be represented by a triangulation.

The out-of-gamut color 404 is a point that is outside the gamut of the device used to recolor the thread. Point 408 on the gamut surface is a point to which the out-of-gamut color would be mapped by a gamut mapping method. The mapped point 408 belongs to an element, i.e., the triangle 406, on the gamut surface. As indicated in the figure, points (P₁, P₂, P₃) are the vertices of this triangle. The points P₁, P₂ and P₃ are pairs of the form (Lab, Inks). These points may be used to perform extrapolation, such as simplex extrapolation, or based on other extrapolation coordinates, to define the ink coordinates of the out-of-gamut color 404. Methods of gamut mapping and construction are described by Ján Morovič, Color Gamut Mapping, Wiley; Jul. 28, 2008, the teachings of which are included herein by reference. Simplex interpolation is described, for example, by Peter Hemingway, n-Simplex Interpolation, Hewlett Packard Laboratories, Report HPL-2002-320, 2002, available at: https://www.hpl.hp.com/techreports/2002/HPL-2002-320.pdf.

In specific embodiments, the present invention provides a method for repurposing a colored thread comprising (a) determining a base-to-target ink formula that specifies one or more ink proportions of one or more inks to apply in re-coloring the colored thread from a base color to a target color, wherein determining said base-to-target ink formula comprises: determining a white-to-target ink formula that specifies proportions of one or more inks required for coloring a white thread to achieve the target color; determining a white-to-base ink formula that specifies proportions of one or more inks required for coloring a white thread to achieve the base color; and responsively to determining the white-to-target and white-to-base ink formulas, determining the base-to-target ink formula, wherein the amount of each given ink specified by the base-to-target ink formula is a function of a difference between the amount of the given ink in the white-to-target ink formula and the amount of the given ink in the white-to-base ink formula; (b) determining a base-to-target ink formula that specifies one or more ink proportions of one or more inks to apply in re-coloring the colored thread from a base color to a target color by: (i) determining a white-to-target ink formula that specifies proportions of one or more inks required for coloring a white thread to achieve the target color; (ii) determining a white-to-base ink formula that specifies proportions of one or more inks required for coloring a white thread to achieve the base color; and (iii) responsively determining the base-to-target ink formula based on (i) and (ii); and (c) determining, when any one of the one or more ink proportions of the white-to-base ink formula are greater than in the white-to-target ink formula, that re-coloring to the target color is not possible; wherein: the amount of each given ink specified by the base-to-target ink formula is a function based on a difference between the amount of the given ink in the white-to-target ink formula and the amount of the given ink in the white-to-base ink formula; and (i) one or more thread parameters; and/or (ii) one or more process parameters; the base color is determined by measuring a color spectrum thereof with a color measuring device or any computing device with a camera input; and the target color is determined by measuring a color spectrum thereof with a color measuring device or any computing device with a camera input.

The method of the invention can further be used for determining which colored thread to choose for repurposing, based on various parameters, such as thread parameters, dyeing process parameters, base color, and target color, and any combination thereof.

Accordingly, the present invention provides a method as defined above for repurposing a colored thread, said method further comprises a step of selecting a thread to re-color to a desired target color, wherein the re-coloring is performed by a dyeing system, the method further comprising: (a) determining a base gamut of possible white-to-base ink formulas, wherein each white-to-base ink formula specifies one or more ink proportions of one or more inks required for coloring a white thread to a color of a base thread, and wherein the base gamut includes only white-to-base ink formulas for which each ink value in the white-to-target ink formula is greater or equal to the value of the respective dye in the white-to-base ink formula; (b) responsively to determining the base gamut, selecting a base thread having a white-to-base ink formula in the base gamut; and (c) responsively determining a base-to-target ink formula for re-coloring the selected base thread to achieve the desired target color.

In specific embodiments thereof, the step of selecting the base color comprises scanning multiple available threads with a color measuring device, wherein the color measuring device is configured to determine thread colors of each of the scanned multiple threads and to determine which of the thread colors is in the base gamut, and wherein the base color is selected as the color of an available thread that is in the base gamut.

In further or alternative specific embodiments, the target color is: (i) outside a white-to-target color gamut of the dyeing system, and wherein the base thread color is outside the white-to-target color gamut and extends the base-to-target gamut of the dyeing system to include the target color; or (ii) a set of multiple target colors, and wherein determining a base gamut of colors of threads that can be re-colored to achieve the target color comprises determining a base gamut of colors of threads that can be re-colored to achieve all the multiple target colors.

It is to be understood that the embodiments described hereinabove are cited by way of example, and that the present invention is not limited to what has been particularly shown and described hereinabove. Computer processing elements described may be dedicated and/or distributed processing elements, implemented over wired and/or wireless networks. Such computing systems may furthermore be implemented by multiple alternative and/or cooperative configurations, such as mobile devices, a data center server or a cloud configuration of processers and data repositories. Processing elements of the system may be implemented in digital electronic circuitry, or in computer hardware, firmware, software, or in combinations thereof. Such elements can be implemented as a computer program product, tangibly embodied in an information carrier, such as a non-transient, machine-readable storage device, for execution by, or to control the operation of, data processing apparatus, such as a programmable processor, computer, or deployed to be executed on multiple computers at one site or distributed across multiple sites. Memory storage may also include multiple distributed memory units, including one or more types of storage media.

Communications between systems and devices described above are assumed to be performed by software modules and hardware devices known in the art. Processing elements and memory storage, such as databases, may be implemented so as to include security features, such as authentication processes known in the art.

Method steps associated with the system and process can be rearranged and/or one or more such steps can be omitted to achieve the same, or similar, results to those described herein.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

1. A method for repurposing a colored thread comprising determining a base-to-target ink formula that specifies one or more ink proportions of one or more inks to apply in re-coloring the colored thread from a base color to a target color, wherein determining said base-to-target ink formula comprises:
determining a white-to-target ink formula that specifies proportions of one or more inks required for coloring a white thread to achieve the target color;
determining a white-to-base ink formula that specifies proportions of one or more inks required for coloring a white thread to achieve the base color;
responsively to determining the white-to-target and white-to-base ink formulas, determining the base-to-target ink formula, wherein the amount of each given ink specified by the base-to-target ink formula is a function of a difference between the amount of the given ink in the white-to-target ink formula and the amount of the given ink in the white-to-base ink formula; and
measuring a color spectrum of the target color with a color measuring device and responsively determining the white-to-target ink formula.

2. The method of claim 1, further comprising determining, when any one of the one or more ink proportions of the white-to-base ink formula are greater than in the white-to-target ink formula, that re-coloring to the target color is not possible.

3. The method of claim 1, wherein the amount of each ink in the base-to-target ink formula is further affected by one or more thread parameters.

4. The method of claim 1, wherein the amount of each ink in the base-to-target ink formula is further affected by one or more process parameters.

5. The method of claim 1, further comprising measuring a color spectrum of the base color with a color measuring device and responsively determining the white-to-base ink formula.

6. (canceled)

7. The method of claim 1, further comprising measuring color values of the base color with an app of a mobile device or any other computing device with a camera input and responsively determining the white-to-base ink formula.

8. The method of claim 1, further comprising storing the base-to-target ink formula in a memory of a digital dyeing system, loading the one or more dyes of the base-to-target ink formula to the dyeing system, loading the colored thread to the dyeing system, and dyeing the colored thread according to the base-to-target ink formula.

9. The method of claim 1, wherein the white-to-target formula defines a color not within a gamut of a dyeing machine used to re-color the colored thread and wherein the white-to-base formula includes an amount of an ink not available on the dying machine, such that re-coloring the colored thread to the target thread color is achievable on the dyeing machine.

10. The method of claim 1, for repurposing a colored thread comprising:
(a) determining a base-to-target ink formula that specifies one or more ink proportions of one or more inks to apply in re-coloring the colored thread from a base color to a target color by: (i) determining a white-to-target ink formula that specifies proportions of one or more inks required for coloring a white thread to achieve the target color; (ii) determining a white-to-base ink formula that specifies proportions of one or more inks required for coloring a white thread to achieve the base color; and (iii) responsively determining the base-to-target ink formula based on (i) and (ii); and
(b) determining, when any one of the one or more ink proportions of the white-to-base ink formula are greater than in the white-to-target ink formula, that re-coloring to the target color is not possible;
wherein:
the amount of each given ink specified by the base-to-target ink formula is a function based on a difference between the amount of the given ink in the white-to-target ink formula and the amount of the given ink in the white-to-base ink formula; and (i) one or more thread parameters; and/or (ii) one or more process parameters;
the base color is determined by measuring a color spectrum thereof with a color measuring device or any computing device with a camera input; and
the target color is determined by measuring a color spectrum thereof with a color measuring device or any computing device with a camera input.

11. The method of claim 1 for repurposing a colored thread, further comprising a step of selecting a thread to re-color to a desired target color, wherein the re-coloring is performed by a dyeing system, the method further comprising:
determining a base gamut of possible white-to-base ink formulas, wherein each white-to-base ink formula specifies one or more ink proportions of one or more inks required for coloring a white thread to a color of a base thread, and wherein the base gamut includes only white-to-base ink formulas for which each ink value in the white-to-target ink formula is greater or equal to the value of the respective dye in the white-to-base ink formula;
responsively to determining the base gamut, selecting a base thread having a white-to-base ink formula in the base gamut; and
responsively determining a base-to-target ink formula for re-coloring the selected base thread to achieve the desired target color.

12. The method of claim 11, wherein selecting the base color comprises scanning multiple available threads with a color measuring device, wherein the color measuring device is configured to determine thread colors of each of the scanned multiple threads and to determine which of the thread colors is in the base gamut, and wherein the base color is selected as the color of an available thread that is in the base gamut.

13. The method of claim 11 or 12, wherein the target color is outside a white-to-target color gamut of the dyeing system, and wherein the base thread color is outside the white-to-target color gamut and extends the base-to-target gamut of the dyeing system to include the target color.

14. The method of claim 11, wherein the target color is a set of multiple target colors, and wherein determining a base gamut of colors of threads that can be re-colored to achieve the target color comprises determining a base gamut of colors of threads that can be re-colored to achieve all the multiple target colors.

15. A system comprising a processor and memory including instructions that when executed on the processor perform a method of repurposing a colored thread, the method comprising determining a base-to-target ink formula that specifies one or more ink proportions of one or more inks to apply in re-coloring the colored thread from a base color to a target color, wherein determining said base-to-target ink formula comprises:
receiving a white-to-target ink formula that specifies proportions of one or more inks required for coloring a white thread to the target color;
receiving a white-to-base ink formula that specifies proportions of one or more dyes required for coloring a white thread to the base color; and
responsively to determining the white-to-target and white-to-base ink formulas, determining the base-to-target formula, wherein the amount of each ink specified by the base-to-target formula is a function of a difference between the amount of the given dye in the white-to-target ink formula and the amount of the given ink in the white-to-base ink formula.

16. The system of claim 15, further comprising determining, when any of the one or more ink proportions of the white-to-base ink formula are greater than in the white-to-target ink formula, that re-coloring to the target color is not possible.

17. The system of claim 15, wherein the amount of each ink in the base-to-target ink formula is further affected by one or more thread parameters.

18. The system of claim 15, wherein the amount of each ink in the base-to-target ink formula is further affected by one or more process parameters.

19. The system of claim 15, wherein said method further comprises measuring: (i) a color spectrum of the base color with a color measuring device and responsively determining the white-to-base ink formula; (ii) a color spectrum of the target color with a color measuring device and responsively determining the white-to-target ink formula; or (iii) color values of the base color with an app of a mobile device or any other computing device with a camera input and responsively determining the white-to-base ink formula.

20. (canceled)

21. (canceled)

22. The system of claim 15, wherein said method further comprises storing the base-to-target ink formula in said system's memory, loading the one or more dyes of the base-to-target ink formula to a dyeing system, loading the colored thread to the dyeing system, and dyeing the colored thread according to the base-to-target ink formula.

23. The system of claim 15, wherein the white-to-target formula defines a color not within a gamut of a dyeing machine used to re-color the colored thread and wherein the white-to-base formula includes an amount of an ink not available on the dying machine, such that re-coloring the colored thread to the target thread color is achievable on the dyeing machine.
